(19) United States
(12) Patent Application Publication
(10) Pub. No.: US 2013/0155434 A1
(43) Pub. Date: Jun. 20, 2013

(54) SORTING A MEDIA STACK USING A SCANNING APPARATUS

(71) Applicant: Gary Alan Kneezel, Webster, NY (US)

(72) Inventor: Gary Alan Kneezel, Webster, NY (US)

(21) Appl. No.: 13/327,828

(22) Filed: Dec. 16, 2011

(51) Int. Cl. G06K 15/02; H04N 1/04

(52) U.S. Cl. 358/1.13; 358/498

(57) ABSTRACT

A scanning apparatus includes a scan element disposed proximate a scan window; a document input holder; a document output holder; an automatic document feeder configured to move sheets of media from the document input holder past the scan window for scanning by the scan element; and a controller including: a first selectable mode that includes ordering a randomly oriented stack of recording medium provided to the automatic document feeder; and a second selectable mode that includes scanning images for information content on documents provided to the automatic document feeder.

### CROSS REFERENCE TO RELATED APPLICATIONS

Reference is made to commonly assigned U.S. patent application Ser. No. ______ filed concurrently herewith by Chen Quan and Robert Cloutier, entitled “Sorting a Media Stack Using a Printer”; U.S. patent application Ser. No. ______ filed concurrently herewith by John R. Fredlund and Chen Quan, entitled “Identifying a Previously Marked Sheet”; and U.S. patent application Ser. No. ______ filed concurrently herewith by Chen Quan, entitled “Printing on a Randomly Ordered Stack of Media”; the disclosures of which are herein incorporated by reference.

### FIELD OF THE INVENTION

The present invention relates generally to a method and apparatus for reusing print media, and more particularly to scanning of print media within a scanning apparatus to determine whether a side of the print media has previously been marked on.

### BACKGROUND OF THE INVENTION

There are many different types of sheet-fed printers used in home and office settings. Such printers typically include a printing path including a print media input holder, a print region, and a printing mechanism. As an example, printing mechanisms can include a printhead, such as an inkjet printhead, that deposits marking material on a sheet of recording medium. Such printheads can span the width of the recording medium, so that printing is done a line at a time. Alternatively, such printheads can be shorter than the recording medium, and are moved by a carriage across the recording medium to print an image a swath at a time. As another example, a printing mechanism can include an energy source, such as a laser, which selectively modifies a surface such that toner particles can be attracted to the surface in an image-wise fashion for subsequent transfer to a sheet of recording medium.

In the past, home or office printing was predominantly done on one side of a sheet of recording medium, and then the sheet was discarded when the printed image was no longer needed. For types of recording media where both sides of the sheet are usable, this represents significant waste. More recently, many printers have included duplexing units so that the user could readily print on both sides of a sheet. Still there are many sheets being printed only on one side.

Increasingly, users of printed media in home and office settings have become environmentally conscious and now recycle printed media. A standard type of recycling is to store up printed media that is no longer needed and send it to a processing center where the waste paper is recovered and remade into new paper products. Recycling of one ton of office or copier paper saves about two tons of wood, reducing the need to cut down trees for paper making. An even more environmentally friendly and cost-conscious measure is to reuse paper that has been printed on. U.S. Pat. No. 6,236,831 discloses scanning a previously printed marking surface, determining a location of printing on the marking surface, and depositing an erasing material, such as an opaque white material or a bleaching compound to conceal or remove marks that were previously made. Most printers, however, do not have the capability for depositing an opaque white material or bleaching compound.

An alternative approach is to reuse recording medium that has previously been printed on one side but not on the other side. A user can remove paper from a recycling storage unit, load it into a printer and print on the side that was not previously marked on. A difficulty with this approach is that recording medium in a recycling storage unit is typically not stored in an orderly fashion with the blank sides facing in a uniform direction, but rather is randomly oriented. The user typically needs to manually sort the stack of recording medium before loading it into the printer.

What is needed is a scanning apparatus and method for sorting a randomly oriented stack of recording media provided to an automatic document feeder of the scanning apparatus.

### SUMMARY OF THE INVENTION

The present invention is directed to overcoming one or more of the problems set forth above. Briefly summarized, according to one aspect of the invention, the invention resides in a scanning apparatus comprising a scan element disposed proximate a scan window; a document input holder; a document output holder; an automatic document feeder configured to move sheets of media from the document input holder past the scan window for scanning by the scan element; and a controller including: a first selectable mode that includes ordering a randomly oriented stack of recording medium provided to the automatic document feeder; and a second selectable mode that includes scanning images for information content on documents provided to the automatic document feeder.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic representation of an inkjet printer system;

FIG. 2 is a perspective of a portion of a printhead;

FIG. 3 is a perspective of a portion of a desktop carriage printer;

FIG. 4 is a schematic side view of an exemplary printing path in a carriage printer;

FIG. 5. is a perspective of a multifunction printer according to an embodiment of the invention;

FIG. 6 is a perspective the multifunction printer of FIG. 5 with the automatic document feeder raised up;

FIG. 7 is a cut-away side view of a scanning apparatus including duplexing capability according to an embodiment of the invention;

FIG. 8 is a cut-away side view of a scanning apparatus including a sorting storage unit, according to an embodiment of the invention; and

FIGS. 9-10 are cut-away side views of the scanning apparatus of FIG. 8 with a pivotable gate in different positions.

### DETAILED DESCRIPTION OF THE INVENTION

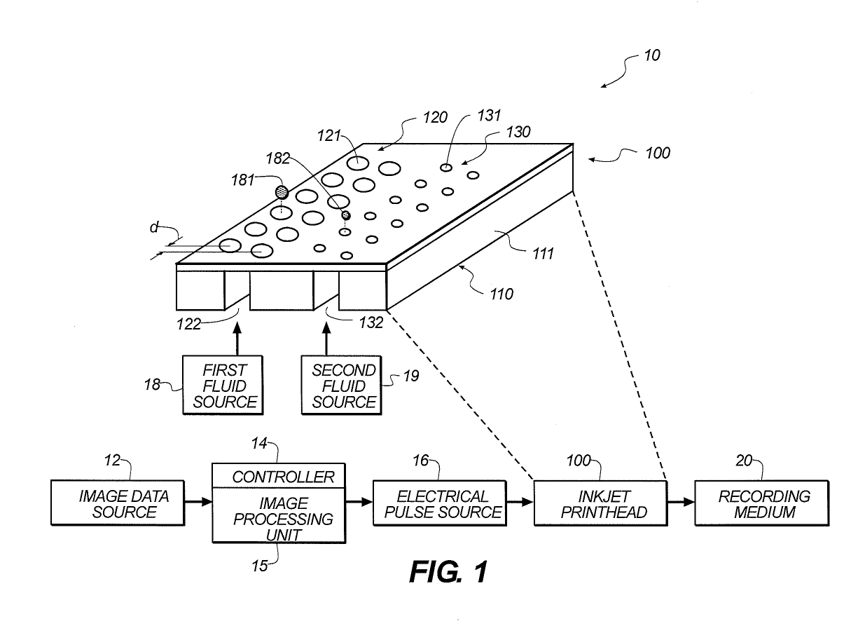

Referring to FIG. 1, a schematic representation of an inkjet printer system 10 is shown, for its usefulness with the present invention and is fully described in U.S. Pat. No. 7,350,902, and is incorporated by reference herein in its entirety. Inkjet printer system 10 includes an image data source 12, which provides data signals that are interpreted by a controller 14 as being commands to eject drops. Image data can include data corresponding to text, graphs, pictures, or other kinds of image content. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays 120, 130, has two staggered rows of nozzles, each row having a nozzle density of 600 per inch. The effective nozzle density then in each array is 1200 per inch (i.e. d= 1/1200 inch in FIG. 1). If pixels on a recording medium 20 were sequentially numbered along the paper advance direction, the nozzles from one row of an array would print the odd numbered pixels, while the nozzles from the other row of the array would print the even numbered pixels.

In fluid communication with each nozzle array 120, 130 is a corresponding ink delivery pathway 122. Ink delivery pathway 122 is in fluid communication with the first nozzle array 120, and an ink delivery pathway 132 is in fluid communication with the second nozzle array 130. Portions of ink delivery pathways 122 and 132 are shown in FIG. 1 as openings through a printhead die substrate 111. One or more inkjet printhead die 110 will be included in inkjet printhead 100, but for greater clarity only one inkjet printhead die 110 is shown in FIG. 1. In FIG. 1, a first fluid source 18 supplies ink to first nozzle array 120 via ink delivery pathway 122, and a second fluid source 19 supplies ink to second nozzle array 130 via ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132 respectively. Also, in some embodiments, fewer than two or more than two nozzle arrays 120, 130 can be included on printhead die 110. In some embodiments, all nozzles 121, 131 on inkjet printhead die 110 can be the same size, rather than having multiple sized nozzles on inkjet printhead die 110.

Not shown in FIG. 1, are the drop forming mechanisms associated with the nozzles 121, 131. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

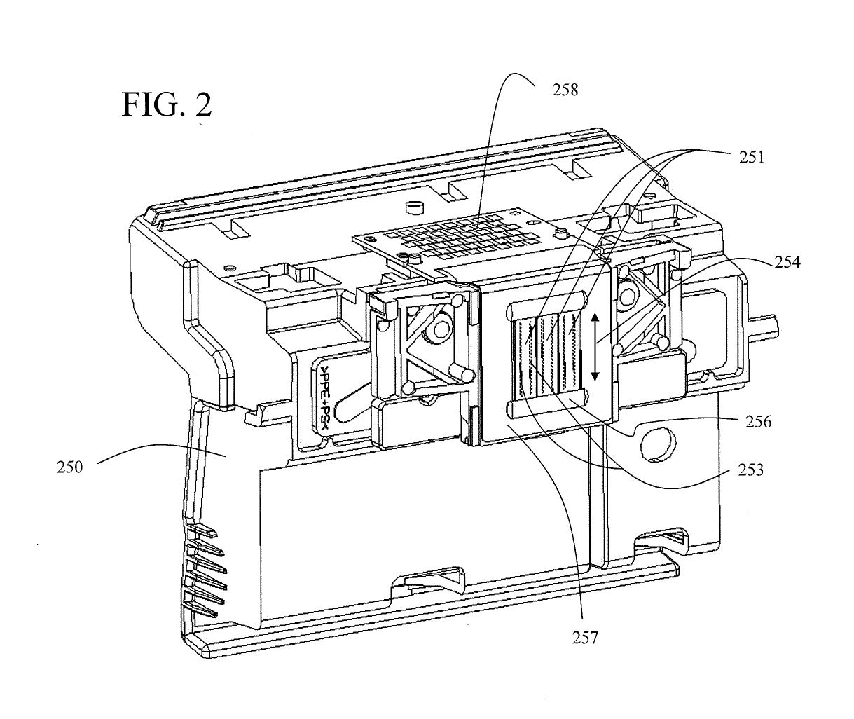

FIG. 2 shows a perspective of a portion of a printhead 250, which is an example of an inkjet printhead 100. Printhead 250 includes three printhead die 251 (similar to printhead die 110 in FIG. 1), each printhead die 251 containing two nozzle arrays 253, so that printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 20. Following the printing of a swath, the recording medium 20 is advanced along a media advance direction that is substantially parallel to nozzle array direction 254.

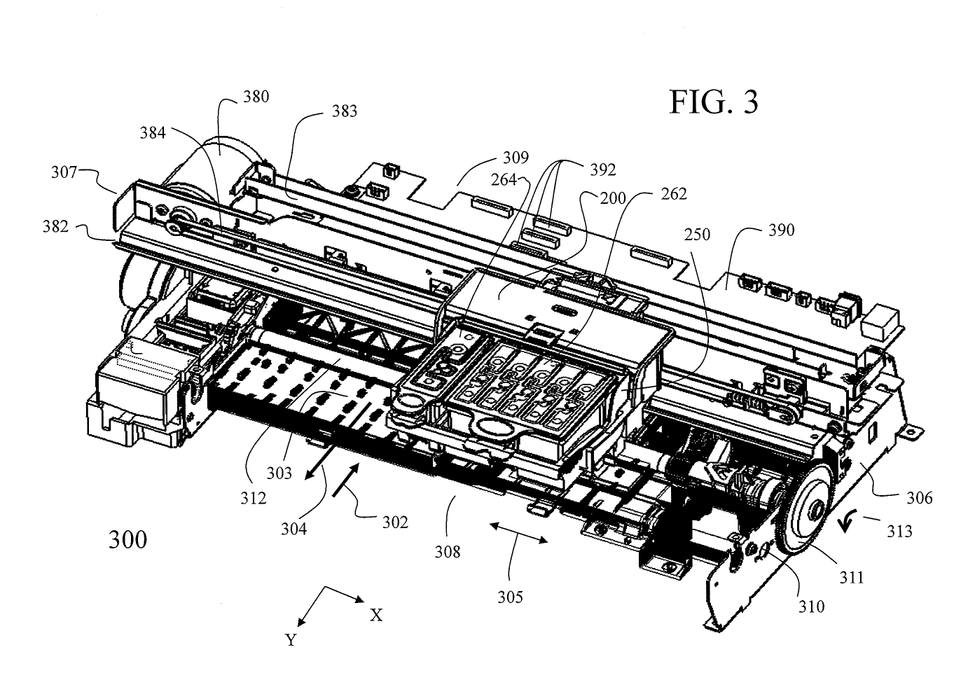

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to connector board 258. When printhead 250 is mounted into a carriage 200 (see FIG. 3), connector board 258 is electrically connected to a connector (not shown) on the carriage 200, so that electrical signals can be transmitted to the printhead die 251.

FIG. 3 shows a portion of a desktop carriage printer. Some of the parts of the printer have been hidden in the view shown in FIG. 3 so that other parts can be more clearly seen. A printing apparatus 300 has a print region 303 across which carriage 200 is moved back and forth in carriage scan direction 305 along the X axis, between a right side 306 and a left side 307 of printing apparatus 300, while drops are ejected from printhead die 251 (not shown in FIG. 3) on printhead 250 that is mounted on carriage 200. Carriage motor 380 moves a belt 384 to move carriage 200 along a carriage guide 382. An encoder sensor (not shown) is mounted on carriage 200 and indicates carriage location relative to an encoder fence 383.

Printhead 250 is mounted in carriage 200, and a multi-chamber ink tank 262 and a single-chamber ink tank 264 are mounted in the printhead 250. The mounting orientation of printhead 250 is rotated relative to the view in FIG. 2, so that the printhead die 251 are located at the bottom side of printhead 250, the droplets of ink being ejected downward onto the recording medium in print region 303 in the view of FIG. 3. Multi-chamber ink tank 262, in this example, contains five ink sources: cyan, magenta, yellow, photo black, and colorless protective fluid; while single-chamber ink tank 264 contains the ink source for text black. Paper or other recording medium (sometimes generically referred to as paper or media herein) is loaded along paper load entry direction 302 toward the front of printing apparatus 308.

The motor that powers the media advance rollers is not shown in FIG. 3, but a hole 310 at the right side of the printing apparatus 306 is where the motor gear (not shown) protrudes through in order to engage feed roller gear 311, as well as the gear for the discharge roller (not shown). A forward direction of rotation 313 is indicated. Toward the rear of the printing apparatus 309 is located an electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

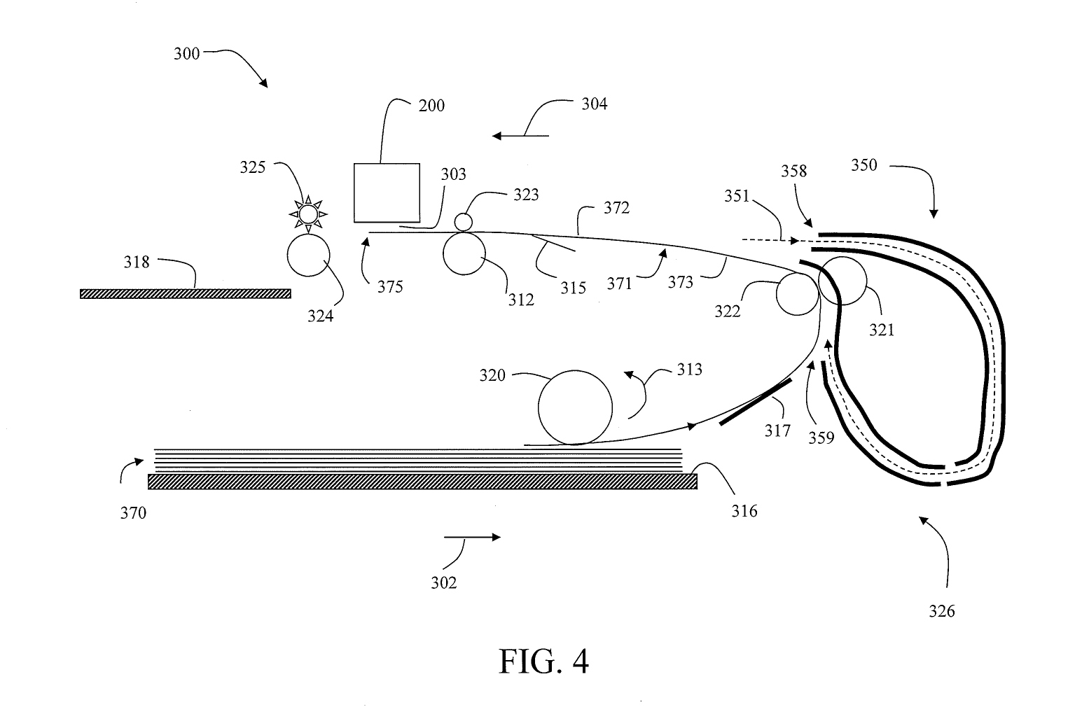

Referring to FIG. 4, the printing apparatus 300 includes a variety of rollers (or other such media transport elements) that are used to advance sheets 371 of a stack 370 of recording medium along a printing path 326 defined as a path from a print media input holder 316 to a print region 303. In the C-shaped paper path example of FIG. 4 (appearing as a backwards C from this view), a print media input holder 316 holds a stack 370 of media. A pick roller 320 is driven to rotate in forward rotation direction 313 to advance the top sheet 371 of the stack 370 of media from print media input holder 316 along paper load entry direction 302 and up inclined guide 317. A turn roller 322 is driven to further advance the sheet of media 371 received from the pick roller around a C-shaped path in cooperation with a curved rear wall surface and a pinch roller 321. As a result, the sheet 371 continues to advance along media advance direction 304 from the rear 309 of the printing apparatus 306 (with reference also to FIG. 3) toward print region 303. The sheet 371 is then advanced by a feed roller 312 (driven to rotate in forward rotation direction 313) and an idler roller(s) 323 to advance the lead edge 375 of sheet 371 to and across print region 303 for printing on first side 372 of sheet 371, and from there to a discharge roller 324 and star wheel(s) 325. If the printing is to occur only on first side 372, discharge roller 324 is driven in forward rotation direction 313 to continue to advance sheet 371 along media advance direction 304 until sheet 371 exits into a print media output holder 318, a portion of which is shown. A rotary encoder (not shown) can be coaxially mounted on the feed roller shaft in order to monitor the angular rotation of the feed roller. The media sensor 315 is positioned near feed roller 312 between turn roller 322 and feed roller 312 in order to detect when a sheet of media is approaching the feed roller 312. In FIG. 4, the sheet 371 has pushed the media sensor 315 down. Also schematically shown in the example of FIG. 4 is a duplexing unit 350 that includes a duplexing media path 351 for reversing the sheet 371 of media in order to print on a second side 373 of the sheet that is opposite first side 372. As indicated by the arrows on duplexing media path 351, sheet 371 of media is moved into the entry 358 of duplexing unit 350 by feed roller 312 and is moved out of the exit 359 by turn roller 322. Other rollers (not shown) can also be included within duplexing unit 350 for advancing sheets 371 through duplexing unit 350.

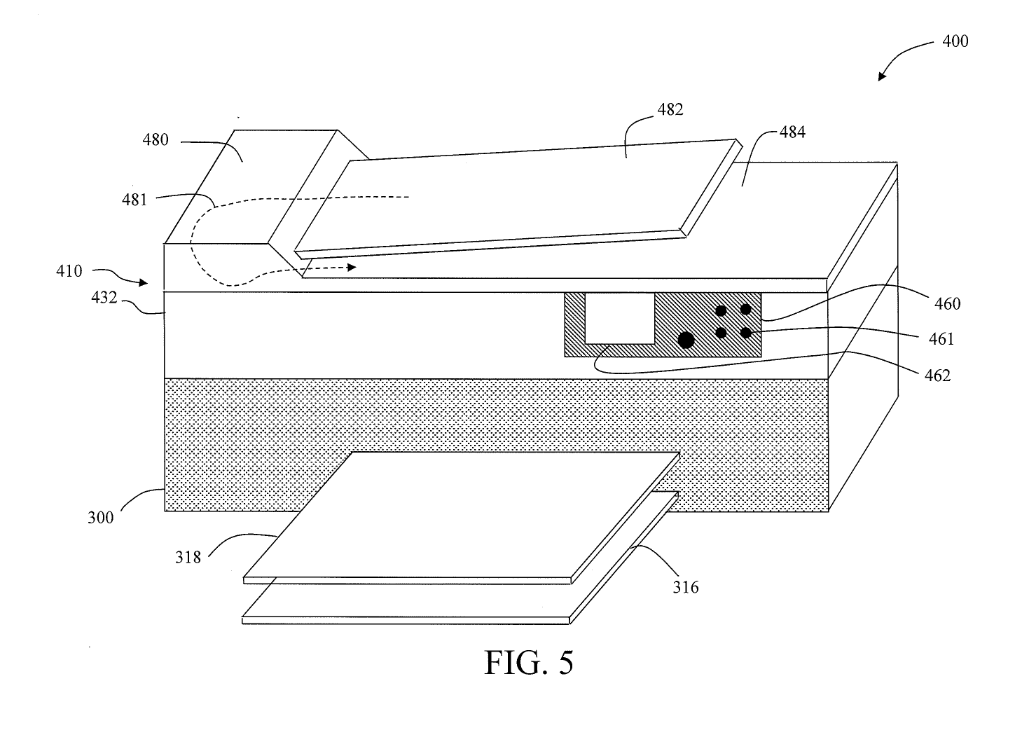

Many commercially available printers are multifunction printers that include document scanning capabilities as well as printing capabilities. FIG. 5 shows a front perspective of a multifunction printer 400 including a scanning apparatus 410 having an automatic document feeder 480, as well as a printing apparatus 300 having a print media input holder 316 and a print media output holder 318. The automatic document feeder (ADF) 480 is capable of automatically loading and unloading single sheets of a stack of documents sequentially to a scanning region (not shown in FIG. 5) for scanning. The scanned document sheets can be copied, faxed, displayed on a computer monitor, stored in memory or the like. The ADF 480 then off-loads a sheet and feeds the immediately following sheet of the document to the scanning region. A sequential flow of sheets by the ADF 480 and positioning without the necessity of manual handling reduces the time required to accomplish the complete scanning of the stack of documents. The ADF 480 can be designed for scanning single-sided originals or two-sided originals. Scanning apparatus 410 includes a document input holder 482 where documents for scanning or copying are stacked, and document output holder 484 for receiving scanned documents. The ADF document scan path 481 from document input holder 482 to document output holder 484 is indicated as a dashed line.

A control panel 460 for the apparatus is shown in FIG. 5 as being located on the front of scanning apparatus 410, but other locations are possible. Control panel 460 can include a display 462 and a variety of control buttons 461, which can include a Start button and a Mode Select button. For cases where display 462 is a touch screen, control buttons 461 can be integrated into the touch screen rather than being separate from it.

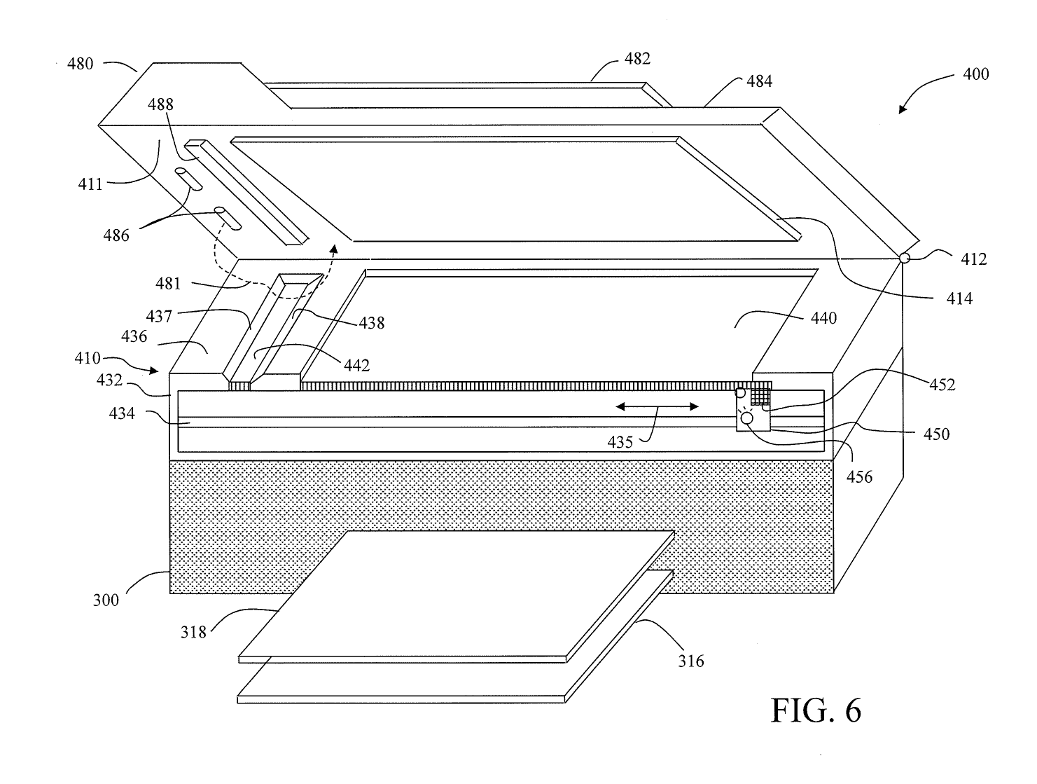

As shown in FIG. 6 (similar to FIG. 5 but with the ADF 480 raised up), ADF 480 can be attached to scanning apparatus body 432 of scanning apparatus 410 by a hinge 412, so that an under side 411 can function as a lid for scanning apparatus 410. The surface of scanning apparatus body 432 that is covered by under side 411 when ADF 480 is closed includes a frame 436. Transparent platen 440 (typically a flat piece of glass) is inset within the frame 436. The front of scanning apparatus 410 is cut away in FIG. 6 in order to show movable scan element 450 below transparent platen 440. Scan element 450 includes a photosensor array 452 (such as a contact image sensor) extending the width of the transparent platen 440, and a light source 456 that illuminates a scan line of a document or other item (not shown) that is manually placed on top of transparent platen 440. A light guide and other optics (not shown) can also be included in scan element 450. Scan element 450 is moved back and forth along scanning guide 434 in scanning direction 435 across the length of transparent platen 440 in order to scan the document or other item, receiving reflected light from the item through the transparent platen 440 scan line by scan line and converting the reflected light into electrical signals. A controller, which can be included in controller 14 of FIG. 1, converts the electrical signals into digitized data to form a digitized image of the item. Scanning guide 434 can be a round rail, a rack and pinion or other guiding member that can use the power of a motor (not shown) to provide a linear motion along the scanning direction 435. A pressing element 414 is provided on under side 411 in order to hold documents or other items manually placed on transparent platen 440 in contact with transparent platen 440 during scanning.

A separate transparent scan window 442 is provided for scanning documents being fed by ADF 480. ADF document scan path 481 below the under side 411 of ADF 480 is shown in FIG. 6. The document to be scanned is moved by a transporter such as rollers 486 down a down ramp 437, across the scan window 442, up an up ramp 438 and toward the under side 411 through which it passes on its way to output tray 484. A pressing member 488 forces the document into contact with scan window 442 for scanning by scan element 450, which is parked below scan window 442 during ADF scanning. During ADF operation, the movable scan element 450 remains stationarily positioned at the automatic scanning region near scan window 442 in order to scan each document as the document is conveyed past transparent platen 442 by the ADF 480.

In embodiments of the present invention, scanning apparatus 410 having an automatic document feeder 480 is used not only to scan documents as is conventionally done, but also to automatically sort and order a randomly oriented stack of previously used recording medium. A controller, such controller 14 of FIG. 1, is provided with two selectable modes of operation. A first selectable mode (a media sort mode) includes ordering a randomly oriented stack of recording medium provided to document feeder 480. A second selectable mode, corresponding to the conventional mode of operation, includes scanning images for information content on documents provided to the automatic document feeder. A difference between the two modes is that in the first mode, what is being evaluated is whether a side of a sheet of recording medium has previously been marked on or not. Particular information content corresponding to previous marks is disregarded. By contrast, in the second mode, the information content of the marks on the document is what is important. Some commercially available scanners, including Kodak scanners that implement “Perfect Page” technology, presently respond to blank sheets differently than sheets having information content. In such scanners, scan data from sheets that are found to be blank or substantially blank is not stored as the scan data from sheets having information content would be. This saves both processing time and memory. However, that is different from the present invention, where in the media sort mode, sheets that are determined to have been previously marked on a first side are moved to a first site, and sheets that are determined not to have been previously marked on the first side are moved to a second site.

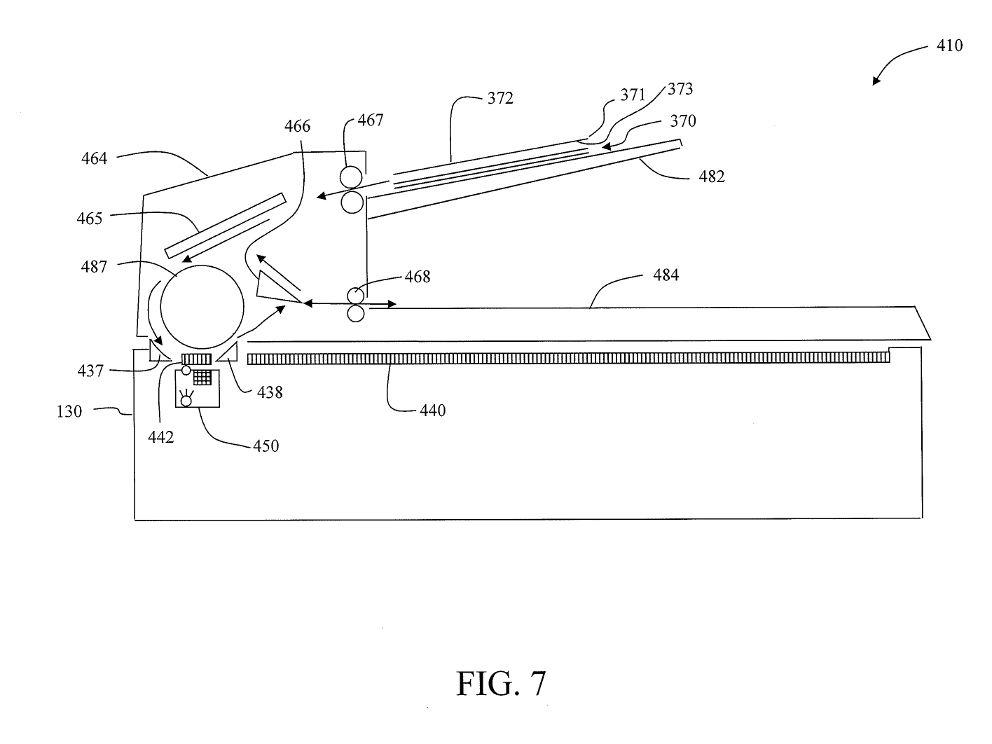

As illustrated in the cut-away side view of FIG. 7, some types of scanning apparatus 400 include duplexing capability in order to permit automatic scanning of both sides of documents. Such duplexing capability can also be useful in sorting and ordering a randomly oriented stack 370 of media. In a first embodiment shown in FIG. 7, a duplexing ADF 464 includes feed rollers 467 located near document input holder 482, as well as reversible duplex rollers 468 located near document output holder 484. A document or a first sheet 371 of a stack 370 of media is fed from document input holder 482 with a first side 372 facing upward. First sheet 371 is moved by feed rollers 467 along a feed guide 465. A large roller 487 then moves first sheet 371 toward scan window 442 as it turns first sheet 371 over so that first side 372 now faces downward toward scan element 450. After scanning of first side 372, first sheet 371 (or correspondingly a first document) can be ejected into document output holder 484. Alternatively, if it is desired to turn first sheet 371 over again so that second side 373 faces downward (and optionally scan second side 373), before first sheet 371 is ejected, duplexing rollers 468 can be driven in a reverse direction to move first sheet 371 past a duplexing guide 466 toward feed guide 465. Optionally duplexing guide 466 can be pivotably mounted to help direct the sheet 371 to its proper location. Large roller 487 then moves first sheet 371 toward scan window 442 as it turns first sheet 371 over so that second side 373 now faces downward.

A method of automatically ordering a randomly oriented stack 370 of media using a scanning apparatus 410 having duplexing capability will next be described. A user loads a stack 370 of previously used recording medium into document input holder 482 and selects the media sort mode, for example by pressing a button. Controller 14 (FIG. 1) recognizes that a media sort mode has been selected. Controller 14 sends instructions to duplexing ADF 464 to feed first sheet 371. As described above, large roller 487 moves first sheet 371 toward scan window 442 as it turns first sheet 371 over so that a first side 372 that formerly faced upward when in document input holder 482 now faces downward toward scan element 450. Scan element 450 scans first side 372 of sheet 371 and provides scan data to controller 14, where the scan data is analyzed to determine whether the first side of the sheet has previously been marked on. Such marks can include printed marks or handwritten marks, for example. Recording media, particularly from a recycling storage unit, can have minor imperfections or dust on it, such that a side having minor imperfections is still satisfactory. Analyzing the scan data (e.g. in controller 14) can include comparing the scan data to a predetermined threshold for detection of marks such that marks having a size or contrast relative to the background of the recording medium that exceed the threshold are included for the purpose of determining whether the first side 372 has previously been marked on. If it is determined via the analyzed scan data that the first side has previously been marked on (i.e. marked on to an extent that would detract from a newly printed image), then before sheet 371 is ejected into document output holder 484, the direction of duplexing rollers 468 is reversed and first sheet is moved along duplexing guide 466 back to large roller 487 as a first site. Large roller 487 moves first sheet 371 in a second pass toward scan window 442 as it turns first sheet 371 over so that a second side 373 now faces downward toward scan element 450. First sheet 371 is then ejected into document output holder 484. If the stack 370 of randomly oriented previously used recording medium has previously been marked on at most one side, second side 373 that faces down in document output holder 484 must be unmarked, because marks were previously detected on first side 372. However, if it is determined via the analyzed scan data that the first side 372 has not previously been marked on (i.e. has not been marked on to an extent that would detract from a newly printed image), then the sheet 371 is ejected directly into document output holder 484 as a second site, without taking a second pass around large roller 487. For sheets that are determined not to have marks on first side 372, unmarked side 372 is facing downward in document output holder 484. The method is repeated for each successive sheet in the randomly oriented stack 370. For a stack 370 of randomly oriented previously used recording medium that has previously been marked on at most one side, such a method and scanning apparatus 410 are effective in ordering the stack 370 such that unmarked sides face downward in the document holder. The ordered stack can then be loaded into print media input tray 316 of printing apparatus 300 (see FIG. 5) for printing. For a C-shaped paper path as described relative to FIG. 4, recording medium should be loaded with the side to be printed facing downward, which is the same orientation of the unmarked sides of the ordered stack.

Previously used recording medium is not always carefully controlled such that the user can be confident that at most one side has previously been marked on. Optionally, the method described above can be modified as follows. If it has been determined that first side 372 of sheet 371 has been marked on, second side 373 is scanned as it is moved past scan element 450. If second side 373 has not been marked on, then sheet 371 can be ejected into document output holder 484. If it is determined that second side 373 has also been marked on, an alarm or message can be provided to the user to remove that sheet from the stack. Such a sorting method can require occasional to frequent user attention, depending on the proportion of the stack 370 that has previously been marked on both sides.

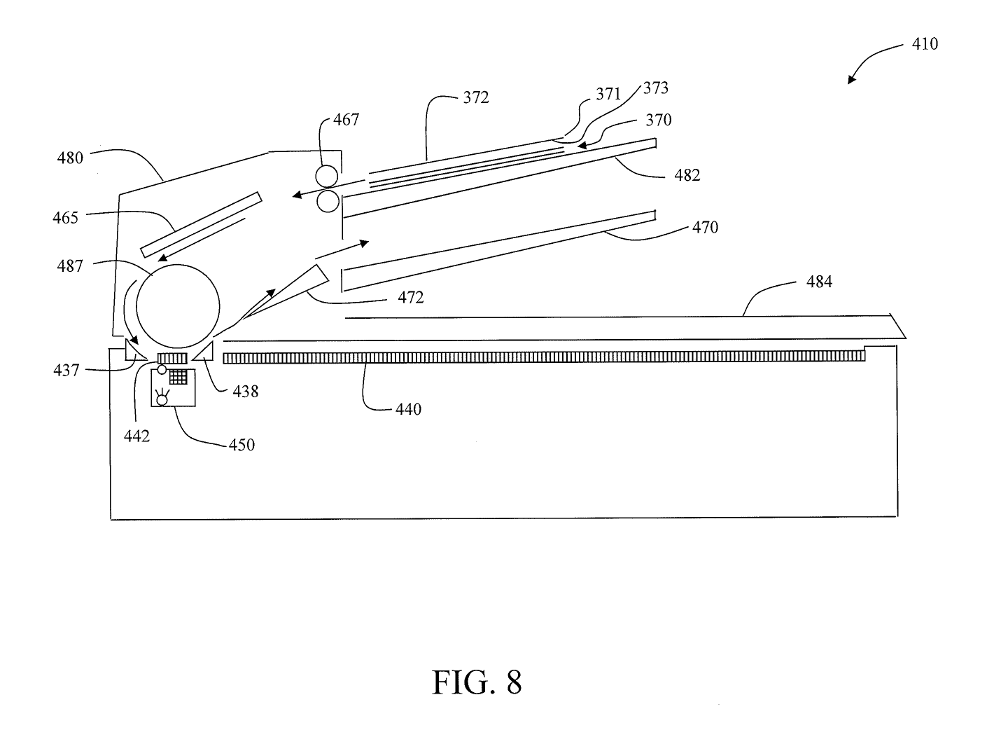

A second embodiment is described relative to the cut-away side views of FIGS. 8-10. In the second embodiment, a sorting storage unit 470 is provided between document input holder 482 and document output holder 484. A pivotable gate 472 is also provided. Scanning apparatus 410 in the example shown in FIGS. 8-10 does not include duplexing capability, but other embodiments (not shown) can include both a sorting storage unit 470 and duplexing capability.

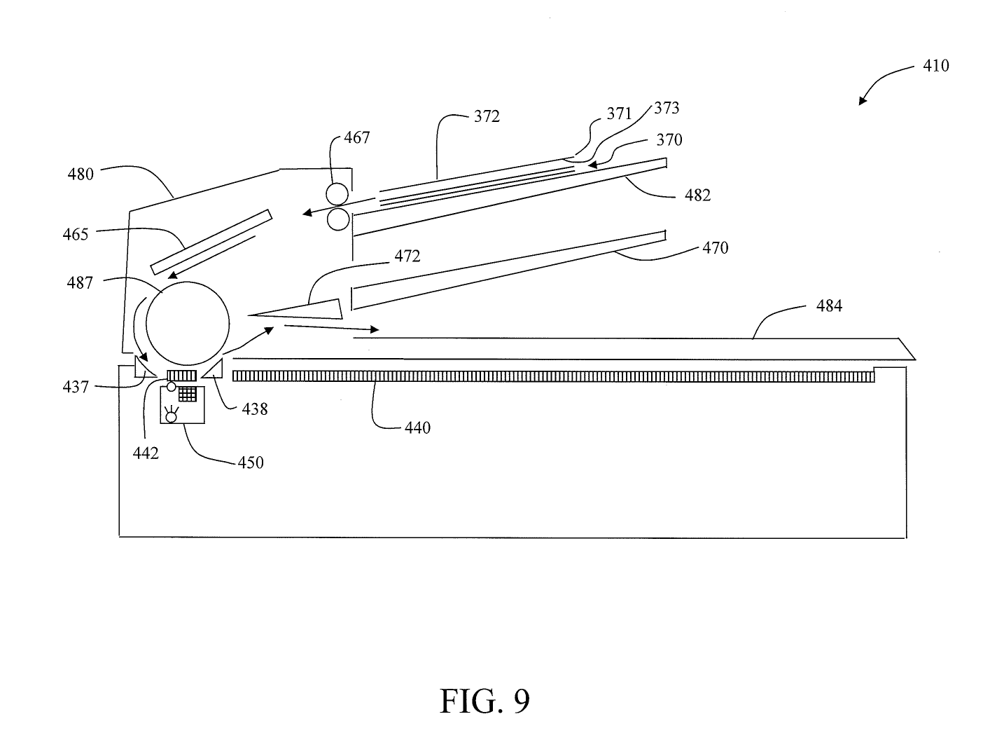

A method of automatically ordering a randomly oriented stack 370 of recording medium using a scanning apparatus 410 having a sorting storage unit 470 will next be described with reference to FIGS. 8-10. A user loads a stack 370 of previously used recording medium into document input holder 482 and selects the media sort mode, for example by pressing a button. Controller 14 (FIG. 1) recognizes that a media sort mode has been selected. Controller 14 sends instructions to duplexing ADF 464 to feed first sheet 371. As described above, large roller 487 moves first sheet 371 toward scan window 442 as it turns first sheet 371 over so that a first side 372 that formerly faced upward when in document input holder 482 now faces downward toward scan element 450. Scan element 450 scans first side 372 of sheet 371 and provides scan data to controller 14, where the scan data is analyzed to determine whether the first side 372 of the sheet has previously been marked on. Such marks can include printed marks or handwritten marks, for example. Recording media, particularly from a recycling storage unit, can have minor imperfections or dust on it, such that a side having minor imperfections is still satisfactory. Analyzing the scan data (e.g. in controller 14) can include comparing the scan data to a predetermined threshold for detection of marks such that marks having a size or contrast relative to the background of the recording medium that exceed the threshold are included for the purpose of determining whether the first side 372 has previously been marked on. If it is determined via the analyzed scan data that the first side 372 has previously been marked on (i.e. marked on to an extent that would detract from a newly printed image), then pivotable gate 472 is pivoted into a position that guides the sheet 371 to sorting storage unit 470 (as a first site), as indicated by the arrows in FIG. 8. If it is determined via the analyzed scan data that the first side has not previously been marked on (i.e. not marked on to an extent that would detract from a newly printed image), then pivotable gate 472 is pivoted into a position that guides the sheet 371 to document output holder 484 (as a second site), as indicated by the arrows in FIG. 9. The steps are repeated such that each sheet in the stack 370 is sequentially moved by the ADF 480 and scanned by scan element 450 to provide scan data that is analyzed to determine whether the first side 372 has previously been marked on. Each sheet is moved accordingly to the sorting storage unit 470 if it is determined that the first side 372 has previously been marked on or to document output holder 484 if it is determined that the first side 372 has not previously been marked on. As a result, there is a first set of sheets in the first site (sorting storage unit 470) with the previously marked first side facing down, and a second set of sheets in the second site (document output holder 484) with the unmarked first side 372 facing down. If it is known that the stack 370 of randomly oriented recording medium had been previously marked at most one side, the first set of sheets can be turned over and added to the second set of sheet, and both sets of sheets can be loaded into a print media input holder 316 (FIG. 5) of the printing apparatus 300, e.g. of the multifunction printer 400.

Alternatively, if it is not known that the stack 370 has previously been marked on at most one side, the first set of sheets in sorting storage unit 470 can then be loaded into document input holder 482 for scanning second side 373. Since the first pass through ADF 480 has already turned the first set of sheets over so that side 372 is facing down and second side 373 is facing up, the first set of sheets can be transferred directly to document input holder 482 without turning them over again. After the second side 373 of the first set of sheets has been scanned and sorted, there is a group of sheets in the first site (sorting storage unit 470) that has previously been marked on both first side 372 and second side 373. This group can be removed and disposed of separately (such as by standard recycling processes). The sheets in the document output holder 484 (both the second set of sheets from the first pass, and the sheets from the first set that were found to have unmarked second sides 373 during the second scanning pass) can be loaded into the print media input holder 316 of the printing apparatus 300 (FIG. 5). If the scanning apparatus 410 and the printing apparatus 300 are both part of the same multifunction printer 400, sorting a randomly oriented stack 370 and loading of sorted media into the print media input holder 316 for subsequent printing is particularly convenient.

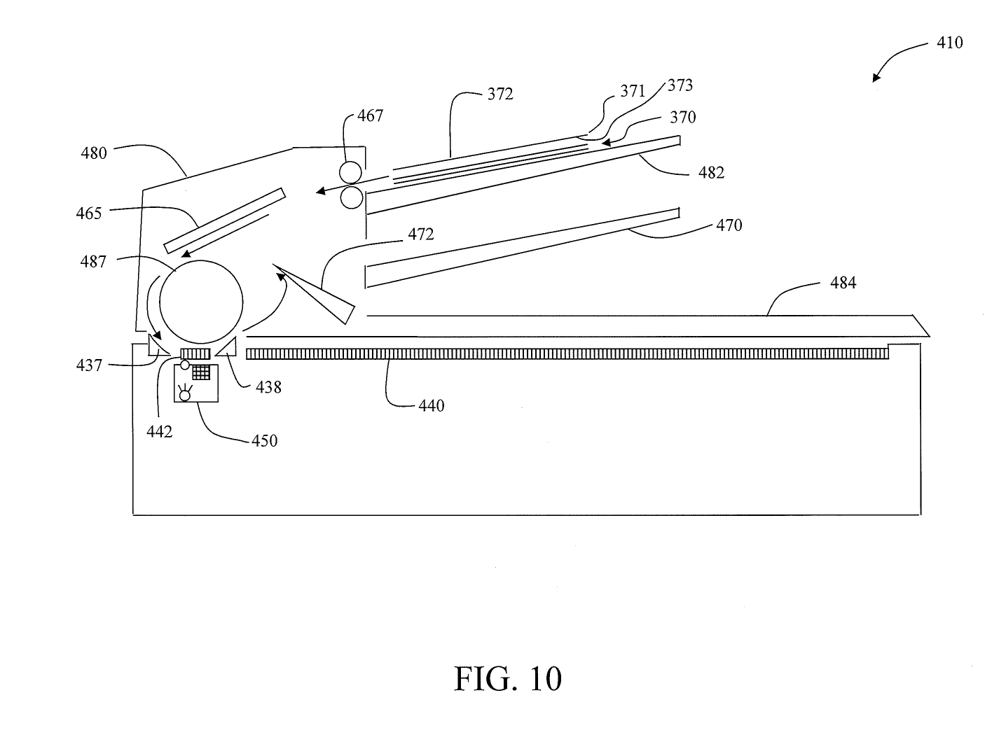

Depending upon the length of the sheets 371 and the length between scan element 450 and pivotable gate 472, in some embodiments it is not possible to complete a scan of first side 372 of a sheet 371 in a first pass through the ADF and analyze the data before a lead edge of the sheet reaches the pivotable gate 472. In such embodiments, each sheet 371 can be sent on two successive passes through the ADF 480. On the first pass, first side 372 is scanned and pivotable gate 472 is moved to a position as shown for example in FIG. 10, so that the sheet 371 is guided back to the feed guide 465 for a second cycle around large roller 487. Then on the second successive pass, the pivotable gate 472 is pivoted to one of the positions shown in FIGS. 8 and 9 for moving the sheet 371 to sorting storage unit 470 or to document output holder 484 depending on whether it was determined that the first side 372 has previously been marked. In such embodiments, since the sheets have made a second pass, they now have the same orientation they originally did (that is, with first side 372 facing up). When the first set of sheets that has previously been marked on the first side is rescanned to sort out sheets that have previously been marked on both sides, the first set of sheets needs to be turned over before loading it back into document input holder 482. Instructions can be provided to the user, for example on display 462 (FIG. 5) as to which way the first set of sheets should be loaded into document input holder 482.

With reference to FIGS. 4 and 5, in the printing apparatus 300 having a C-shaped printing path 326, recording medium needs to be loaded into print media input holder 316 with the side to be printed facing downward. For a printing apparatus having an L-shaped printing path (not shown), recording medium needs to be loaded with the side to be printed facing outward because the sheets are not turned over on their way to print region 303. For a multifunction printer 400 including a scanning apparatus 410 that can sort a randomly ordered stack of recording medium, the multifunction printer 400 can provide instructions as to how the ordered sheets (the second set, or the second set plus the members of the rescanned first set having no marks on second side 373) should be oriented—i.e. whether they should be turned over or not—before loading them into print media input holder 316. Similarly, instructions can be provided about placing the first set of sheets into the document input holder 482 and whether or not to turn the first set of sheets over before rescanning them.

The invention has been described in detail with particular reference to certain preferred embodiments thereof, but it will be understood that variations and modifications can be effected within the spirit and scope of the invention. In particular, although embodiments were described with regard to multifunction inkjet printers, the invention is applicable to other types of multifunction printers and standalone scanning apparatus as well.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Printhead
251 Printhead die
253 Nozzle array
254 Nozzle array direction
256 Encapsulant
257 Flex circuit
258 Connector board
262 Multi-chamber ink tank
264 Single-chamber ink tank
300 Printing apparatus
301 Base
302 Paper load entry direction
303 Print region
304 Media advance direction
305 Carriage scan direction
306 Right side of printing apparatus
307 Left side of printing apparatus
308 Front of printing apparatus
309 Rear of printing apparatus
310 Hole (for paper advance motor drive gear)
311 Feed roller gear
312 Feed roller
313 Forward rotation direction (of feed roller)
314 Reverse rotation direction (of feed roller)
315 Media sensor
316 Print media input holder
317 Inclined guide
318 Print media output holder
320 Pick roller
321 Pinch roller
322 Turn roller
323 Idler roller
324 Discharge roller
325 Star wheel(s)
326 Printing path
335 Scan element
350 Duplexing unit
351 Duplexing media path
358 Entry (to duplexing unit)
359 Exit (from duplexing unit)
370 Stack
371 Sheet
372 First side (of sheet)
373 Second side (of sheet)
375 Lead edge (of sheet)
380 Carriage motor
382 Carriage guide
383 Encoder fence
384 Belt
390 Electronics board
392 Cable connectors
400 Multifunction printer
410 Scanning apparatus
411 Under side of automatic document feeder
412 Hinge
414 Pressing plate
432 Scanning apparatus body
434 Scanning guide
435 Scanning direction
436 Frame
437 Down ramp
438 Up ramp
440 Transparent platen
442 Scan window
450 Scan element
452 Photosensor array
456 Light source
460 Control panel
461 Control buttons
462 Display
464 Duplexing ADF
465 Feed guide
466 Duplexing guide
467 Feed rollers
468 Duplexing rollers
470 Sorting storage unit
472 Pivotable gate
480 Automatic document feeder
481 ADF document scan path
482 Document input holder
484 Document output holder
486 Rollers
487 Large roller
488 Pressing member

1. A scanning apparatus comprising:
a scan element disposable proximate a scan window;
a document input holder;
a document output holder;
an automatic document feeder configured to move sheets of media from the document input holder past the scan window for scanning by the scan element; and
a controller including:
a first selectable mode that includes ordering a randomly oriented stack of recording medium provided to the automatic document feeder; and
a second selectable mode that includes scanning images for information content on documents provided to the automatic document feeder.

2. The scanning apparatus of claim 1 further comprising a sorting storage unit.

3. The scanning apparatus of claim 1, further comprising duplexing capability.

4. A multifunction printer comprising:
a printing apparatus including a print media input holder; and
a scanning apparatus including:
a scan element disposed proximate a scan window;
a document input holder;
a document output holder;
an automatic document feeder configured to move sheets of media from the document input holder past the scan window for scanning by the scan element; and
a controller including:
a first selectable mode that includes ordering a randomly oriented stack of recording medium provided to the automatic document feeder for loading into the print media input holder of the printing apparatus; and
a second selectable mode that includes scanning images for information content on documents provided to the automatic document feeder.

5. The multifunction printer of claim 4, wherein the scanning apparatus further includes a sorting storage unit.

6. The multifunction printer of claim 4, wherein the scanning apparatus further includes duplexing capability.

7. A method of automatically ordering a randomly oriented stack of recording medium provided to an automatic document feeder of a scanning apparatus, the method comprising:
(a) using the automatic document feeder to move a sheet of recording medium past a scan element of the scanning apparatus;
(b) using the scan element to scan a first side of the sheet of recording medium to provide scan data;
(c) analyzing the scan data to determine whether the first side of the sheet has previously been marked on;
(d) moving the sheet to a first site in the scanning apparatus if it is determined that the first side has been previously marked on; and
(e) moving the sheet to a second site in the scanning apparatus if it is determined that the first side has not been previously marked on.

8. The method according to claim 7, wherein the first location includes a sorting storage unit.

9. The method according to claim 7, wherein the scanning apparatus includes duplexing capability.

10. The method according to claim 7, wherein moving the sheet to the first site includes using the duplexing capability to turn the sheet over.

11. The method according to claim 7 further comprising repeating steps (a) through (e) for each successive sheet in the randomly oriented stack of recording media, thereby providing a first set of sheets in the first site and a second set of sheets in the second site.

12. The method according to claim 11 further comprising:
providing the first set of sheets to the automatic document feeder; and
repeating steps (a) through (d) for each successive sheet in the first set of sheets, thereby providing a group of sheets in the first site of the scanning apparatus, wherein each sheet in the group of sheets has previously been marked on both the first side and on a second side opposite the first side.

13. The method according to claim 11, the scanning apparatus being included in a multifunction printer, the method further comprising loading the second set of sheets of recording medium into a print media input holder of a printing apparatus of the multifunction printer for subsequent printing.

14. The method according to claim 11, the scanning apparatus being included in a multifunction printer, the method further comprising:
turning over the first set of sheets;
adding the turned over first set of sheets to the second set of sheets; and
loading the first and second sets of sheets of recording medium into a print media input holder of a printing apparatus of the multifunction printer for subsequent printing.

15. The method according to claim 11 further comprising:
providing instructions to place the first set of sheets at an input to the automatic document feeder; and
repeating steps (a) through (d) for each successive sheet in the first set of sheets, thereby providing a group of sheets in the first site of the scanning apparatus, wherein each sheet in the group of sheets has previously been marked on both the first side and on a second side opposite the first side.

16. The method according to claim 11, the scanning apparatus being included in a multifunction printer, the method further comprising providing instructions to load the second set of sheets of recording medium into a print media input holder of a printing apparatus of the multifunction printer for subsequent printing.

17. The method according to claim 11, the scanning apparatus being included in a multifunction printer, the method further comprising:
providing instructions to add the first set of sheets to the second set of sheets; and
providing instructions to load the first and second sets of sheets of recording medium into a print media input holder of a printing apparatus of the multifunction printer for subsequent printing.

18. The method according to claim 11 further including recognizing that a media sort mode has been selected.
